(19) United States
(12) Patent Application Publication
(10) Pub. No.: US 2025/0303614 A1
(43) Pub. Date: Oct. 2, 2025

(54) MOLD AND THREE-DIMENSIONAL MODELING COMPOSITION

(71) Applicant: SEIKO EPSON CORPORATION, Tokyo (JP)

(72) Inventor: Tatsuya TSUBOI, Okaya (JP)

(21) Appl. No.: 19/090,696

(22) Filed: Mar. 26, 2025

(30) Foreign Application Priority Data
Mar. 28, 2024 (JP) 2024-054213

(51) Int. Cl. B29C 33/38; B29C 45/26; B33Y 70/10; B33Y 80/00

(52) U.S. Cl. CPC B29C 33/3807; B29C 45/26; B33Y 70/10; B33Y 80/00

(57) ABSTRACT

The mold according to the present disclosure is a mold for use in injection molding having a deposited structure in which a plurality of layers are deposited. The mold is made of a material containing inorganic particles surface-modified with a silane coupling agent, and a thermoplastic resin, and has a bending stress of 120 MPa or more as measured by a three-point bending strength test. The mold preferably has an elastic modulus of 8300 MPa or more as measured by the three-point bending strength test.

The present application is based on, and claims priority from JP Application Serial Number 2024-054213, filed Mar. 28, 2024, the disclosure of which is hereby incorporated by reference herein in its entirety.

### BACKGROUND

### 1. Technical Field

The present disclosure relates to a mold and a three-dimensional modeling composition.

### 2. Related Art

An injection molding apparatus that supplies a material plasticized by a plasticizing device to a cavity provided in a mold to mold a molded article is known.

For example, JP-A-2017-124593 states that a mold of an injection molding apparatus is modeled using a three-dimensional modeling machine. The three-dimensional modeling machine can integrally model a shape that cannot be formed in the related art.

Examples of a method for producing a modeled object using a three-dimensional modeling machine include a fused deposition molding (FDM, “FDM” is a registered trademark) in which a layer is formed by ejecting, in a plasticized state, a three-dimensional modeling composition containing inorganic particles such as metal particles and a thermoplastic resin.

In the three-dimensional modeling composition, a silane coupling agent is applied in order to improve compatibility between the inorganic particles and the resin (see, for example, JP-A-2016-112793).

However, in the related art, the strength of the mold manufactured by the three-dimensional modeling method cannot be sufficiently high.

For example, since the pressure during injection molding is as high as 100 MPa to 200 MPa, there is a possibility that a fine structure or a thin portion of a mold is damaged during injection molding.

### SUMMARY

The present disclosure has been made to solve the above problems and can be implemented as the following application examples.

A mold according to an application example of the present disclosure is a mold for use in injection molding having a deposited structure in which a plurality of layers are deposited. The mold is made of a material containing inorganic particles surface-modified with a silane coupling agent and a thermoplastic resin, and has a bending stress of 120 MPa or more as measured by a three-point bending strength test.

A three-dimensional modeling composition according to an application example of the present disclosure contains inorganic particles surface-modified with a silane coupling agent, and a thermoplastic resin. A content of the silane coupling agent with respect to a unit surface area of the inorganic particles is 0.00233 g/m² or more and 0.00933 g/m² or less.

### BRIEF DESCRIPTION OF THE DRAWINGS

FIG. 1 is a cross-sectional view schematically showing a configuration example of an injection molding apparatus using a mold according to the present disclosure.

FIG. 2 is a perspective view schematically showing a flat screw of the injection molding apparatus.

FIG. 3 is a diagram schematically showing barrel of the injection molding apparatus.

FIG. 4 is an exploded perspective view schematically showing a configuration example of the mold of the injection molding apparatus.

FIG. 5 is a perspective view schematically showing a deposited body for the mold.

FIG. 6 is a cross-sectional view taken along a line V I-VI in FIG. 5 and schematically showing a deposited body for the mold.

FIG. 7 is a flowchart illustrating a method for manufacturing the mold.

FIG. 8 is a diagram schematically showing a configuration example of a three-dimensional modeling device used for manufacturing a mold.

FIG. 9 is a cross-sectional view schematically showing a modeling unit.

FIG. 10 is a cross-sectional view schematically showing a step of manufacturing a deposited body by the three-dimensional modeling device.

FIG. 11 is a table showing evaluation results of three-dimensional modeling compositions of Examples and Comparative Examples together with compositions.

FIG. 12 is an image obtained by performing image J (image processing) on an image obtained by measuring, by a digital microscope (VHV), a strand ejected using the three-dimensional modeling composition of Example 1 containing KBP-90 manufactured by Shin-Etsu Chemical Co., Ltd. as a silane coupling agent.

FIG. 13 is an image obtained by performing image J (image processing) on an image obtained by measuring, by a digital microscope (VHV), a strand ejected using the three-dimensional modeling composition of Example 2 containing KBM-803 manufactured by Shin-Etsu Chemical Co., Ltd. as a silane coupling agent.

### DESCRIPTION OF EMBODIMENTS

A preferred embodiment of the present disclosure will be described below in detail.

### 1 Mold

First, a mold according to the present disclosure will be described.

The mold according to the present disclosure is a mold for use in injection molding having a deposited structure in which a plurality of layers are deposited. The mold is made of a material containing inorganic particles surface-modified with a silane coupling agent, and a thermoplastic resin, and has a bending stress of 120 MPa or more as measured by a three-point bending strength test.

A mold for injection molding, which has excellent strength and in which inorganic particles are effectively prevented from falling off, can be provided when such conditions are satisfied. Damage to the mold during injection molding can be effectively prevented when such a mold is used. In addition, for example, when a shape is adjusted by cutting a mold as a modeled object obtained by a three-dimensional modeling method, the inorganic particles can be suitably prevented from unintentionally falling off from a surface of the mold. As a result, the dimensional accuracy of the mold can be increased.

More specifically, when the bending stress of the mold is within the above range, a mechanical strength of the mold can be sufficiently high, and damage during injection molding, particularly damage in a fine structure or a thin portion, can be prevented. In particular, when the inorganic particles are surface-modified with the silane coupling agent, the adhesion between the inorganic particles and the thermoplastic resin is high, and accordingly, the mechanical strength of the mold can be improved, and the inorganic particles can be prevented from falling off from the surface of the mold.

In the present disclosure, the bending stress of the mold refers to a value obtained by measuring a target mold, in particular, a test piece cut out in a predetermined size from a part having the deposited structure in which a plurality of layers are deposited as described above, by a three-point bending test using a three-point bending test jig in accordance with a method described in JIS K7171: 2016.

In contrast, when the above conditions are not satisfied, the above excellent effects cannot be obtained.

For example, when the inorganic particles are not surface-modified with the silane coupling agent, the adhesion to the thermoplastic resin cannot be sufficiently high, and the mechanical strength of the mold cannot be sufficiently high. In addition, for example, the inorganic particles cannot be sufficiently prevented from falling off the surface of the mold when the mold is manufactured by cutting the modeled object obtained by the three-dimensional modeling method.

When the bending stress of the mold is less than the above lower limit value, the mechanical strength of the mold cannot be sufficiently increased, and damage during injection molding cannot be sufficiently prevented.

As described above, the bending stress of the mold according to the present disclosure may be 120 MPa or more, and is preferably 140 MPa or more, and more preferably 150 MPa or more.

Accordingly, the above-described effects of the present disclosure can be more remarkable.

The mold according to the present disclosure preferably has an elastic modulus of 8300 MPa or more, more preferably 8400 MPa or more, and still more preferably 8500 MPa or more as measured by the three-point bending strength test. The upper limit value of the elastic modulus of the mold according to the present disclosure as measured by the three-point bending strength test is not particularly limited, and may be 8600 MPa or less.

Accordingly, the mechanical strength, particularly the rigidity of the mold can be further improved.

In the present disclosure, a value obtained by measuring, by the three-point bending test using a three-point bending test jig in accordance with the method described in JIS K7171: 2016, a test piece cut out in a predetermined size from a target mold can be adopted as the elastic modulus of the mold. In addition, at least a part of an injection molded article may be used instead of the above test piece.

### 1-1 Injection Molding Apparatus

### 1-1-1 Overall Configuration

An injection molding apparatus using the mold according to the present disclosure will be described with reference to the drawings.

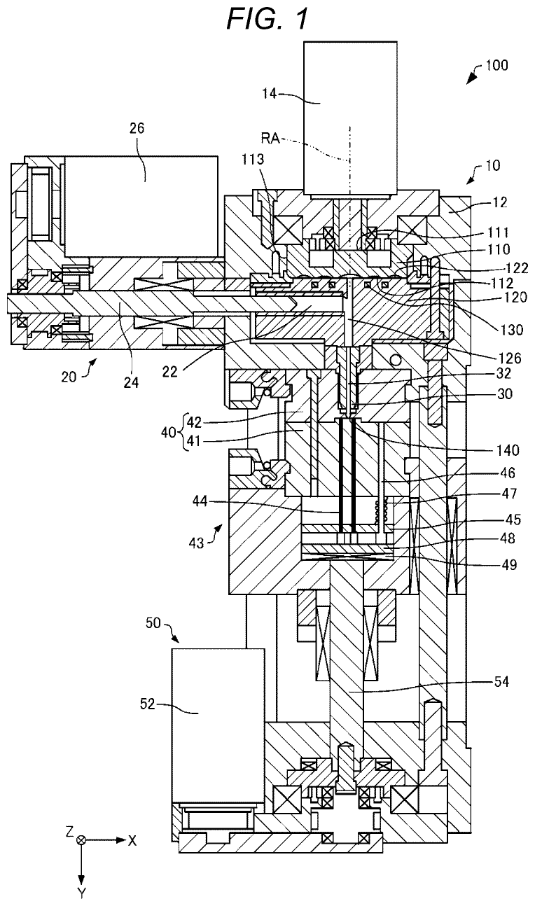

FIG. 1 is a cross-sectional view schematically showing a configuration example of the injection molding apparatus using the mold according to the present disclosure. FIG. 1 shows an X axis, a Y axis, and a Z axis as three axes perpendicular to one another.

As shown in FIG. 1, an injection molding apparatus 100 includes, for example, a plasticizing device 10, an injection mechanism 20, a nozzle 30, a mold 40, and a mold clamping device 50.

The plasticizing device 10 is configured to plasticize a supplied material, generate a paste-shaped plasticized material having fluidity, and guide the plasticized material to the injection mechanism 20.

In the present specification, the term “plasticize” refers to a concept including melting and means changing a solid state to a fluid state. Specifically, in the case of a material in which glass transition occurs, the term “plasticize” refers to setting a temperature of the material to be equal to or higher than a glass transition point. In the case of a material in which glass transition does not occur, the term “plasticize” refers to setting the temperature of the material to be equal to or higher than a melting point.

The material supplied to the plasticizing device 10 is, for example, a resin. More specifically, examples of the material include an ABS resin, polypropylene, polyethylene, polyacetal, polyvinyl chloride, polyamide, polylactic acid, polycarbonate, modified polyphenylene ether, polybutylene terephthalate, polyethylene terephthalate, polysulfone, polyethersulfone, polyarylate, polyimide, polyamideimide, and polyetherimide. The melting point of the material supplied to the plasticizing device 10 is lower than a melting point of a material forming the mold 40.

The plasticizing device 10 includes, for example, a screw case 12, a drive motor 14, a flat screw 110, a barrel 120, and a heater 130.

The screw case 12 is a housing that accommodates the flat screw 110. The flat screw 110 is accommodated in a space surrounded by the screw case 12 and the barrel 120.

The drive motor 14 is provided on the screw case 12. The drive motor 14 rotates the flat screw 110.

The flat screw 110 has a substantially cylindrical shape in which a size in a direction of a rotation axis RA is smaller than a size in a direction perpendicular to the direction of the rotation axis RA. In an example shown in the drawing, the rotation axis RA is parallel to the Y axis. The flat screw 110 is rotated about the rotation axis RA by a torque generated by the drive motor 14. The flat screw 110 has a main surface 111, a groove formation surface 112 opposite to the main surface 111, and a coupling surface 113 that couples the main surface 111 and the groove formation surface 112.

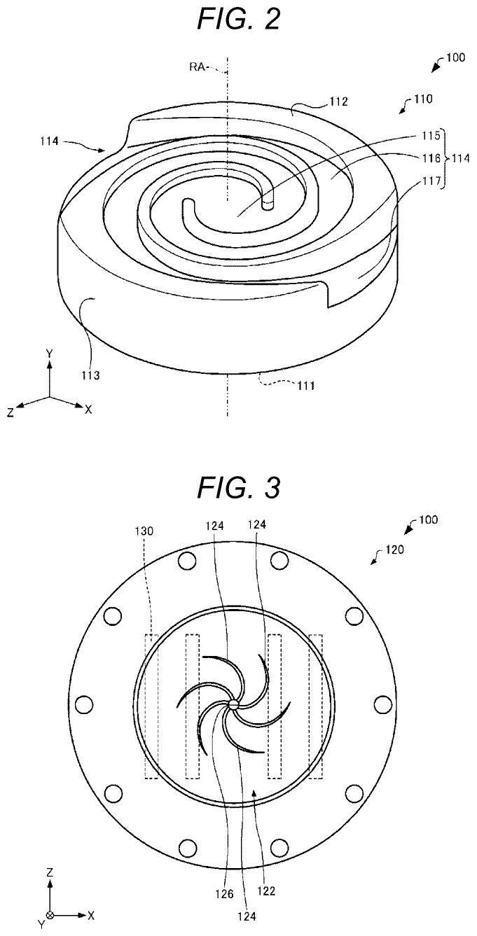

Here, FIG. 2 is a perspective view schematically showing the flat screw 110 of the injection molding apparatus 100. For convenience, FIG. 2 shows a state in which an upper-lower positional relation is reversed from a state shown in FIG. 1. In addition, the flat screw 110 is shown in a simplified manner in FIG. 2.

As shown in FIG. 2, first grooves 114 are formed in the groove formation surface 112 of the flat screw 110. The first groove 114 includes, for example, a central portion 115, a coupling portion 116, and a material introduction portion 117. The central portion 115 faces a communication hole 126 provided in the barrel 120. The central portion 115 communicates with the communication hole 126. The coupling portion 116 couples the central portion 115 and the material introduction portion 117. In the shown example, the coupling portion 116 is provided in a spiral shape from the central portion 115 toward an outer periphery of the groove formation surface 112. The material introduction portion 117 is provided on the outer periphery of the groove formation surface 112. That is, the material introduction portion 117 is provided on the coupling surface 113. The supplied material is introduced from the material introduction portion 117 into the first groove 114, passes through the coupling portion 116 and the central portion 115, and is conveyed to the communication hole 126 provided in the barrel 120. In the example shown in the drawing, two first grooves 114 are provided.

The number of the first grooves 114 is not particularly limited. Three or more first grooves 114 may be provided, or only one first groove 114 may be provided.

As shown in FIG. 1, the barrel 120 faces the flat screw 110. The barrel 120 has a facing surface 122 that faces the groove formation surface 112 of the flat screw 110. The communication hole 126 is provided at a center of the facing surface 122. Here, FIG. 3 is a diagram schematically showing the barrel 120 of the injection molding apparatus 100. For convenience, in FIG. 1, the barrel 120 is shown in a simplified manner.

As shown in FIG. 3, second grooves 124 and the communication hole 126 are provided in the facing surface 122 of the barrel 120. A plurality of second grooves 124 are provided. In the example shown in the drawing, six second grooves 124 are provided, and the number of the second grooves 124 is not particularly limited. The plurality of second grooves 124 are provided around the communication hole 126 when viewed from a Y-axis direction. The second grooves 124 each have one end coupled to the communication hole 126 and extend in a spiral shape from the communication hole 126 toward an outer periphery of the facing surface 122. The second groove 124 has a function of guiding the plasticized material to the communication hole 126.

A shape of the second groove 124 is not particularly limited and may be, for example, a linear shape. The one end of the second groove 124 may not be coupled to the communication hole 126. Further, the second groove 124 may not be provided in the facing surface 122. However, in consideration of efficiently guiding the plasticized material to the communication hole 126, the second groove 124 is preferably provided in the facing surface 122.

The heater 130 is provided in the barrel 120. In the illustrated example, the heater 130 includes four rod heaters provided in the barrel 120. The heater 130 heats the material supplied between the flat screw 110 and the barrel 120. The plasticizing device 10 forms the plasticized material by heating the material while conveying the material toward the communication hole 126 by the flat screw 110, the barrel 120, and the heater 130, and causes the formed plasticized material to flow out of the communication hole 126 to the injection mechanism 20.

As shown in FIG. 1, the injection mechanism 20 includes, for example, a cylinder 22, a plunger 24, and a plunger drive unit 26. The cylinder 22 is a substantially cylindrical member coupled to the communication hole 126. The plunger 24 moves inside the cylinder 22. The plunger 24 is driven by the plunger drive unit 26 implemented by a motor, a gear, and the like.

The injection mechanism 20 performs a metering operation and an injection operation by causing the plunger 24 to slide in the cylinder 22. The metering operation refers to an operation of guiding the plasticized material positioned in the communication hole 126 into the cylinder 22 by moving the plunger 24 in an-X-axis direction away from the communication hole 126 and metering the plasticized material in the cylinder 22. The injection operation refers to an operation of injecting the plasticized material in the cylinder 22 into the mold 40 through the nozzle 30 by moving the plunger 24 in an +X-axis direction approaching the communication hole 126.

The nozzle 30 is provided with a nozzle hole 32 communicating with the communication hole 126. The plasticized material supplied from the plasticizing device 10 is injected into the mold 40 through the nozzle hole 32. Specifically, the plasticized material metered in the cylinder 22 is sent from the injection mechanism 20 to the nozzle hole 32 through the communication hole 126 by executing the metering operation and the injection operation described above. Then, the plasticized material is injected from the nozzle hole 32 into the mold 40.

The mold 40 includes a movable mold 41 and a fixed mold 42. The movable mold 41 and the fixed mold 42 face each other. The mold 40 has a cavity 140 corresponding to a shape of a molded article between the movable mold 41 and the fixed mold 42. At least one of the movable mold 41 and the fixed mold 42 is provided with protruding and recessed portions that define the cavity 140. The plasticized material flowing out of the communication hole 126 is pressure-fed by the injection mechanism 20 and injected from the nozzle 30 to the cavity 140. Details of the movable mold 41 and the fixed mold 42 will be described below.

The mold clamping device 50 includes a mold drive unit 52 and has a function of opening and closing the movable mold 41 and the fixed mold 42. In the mold clamping device 50, a ball screw 54 is rotated by driving the mold drive unit 52 implemented by a motor, and the movable mold 41 coupled to the ball screw 54 is moved relative to the fixed mold 42 to open and close the mold 40. The fixed mold 42 is stationary in the injection molding apparatus 100, and the mold 40 is opened and closed when the movable mold 41 moves relative to the fixed mold 42.

The movable mold 41 is provided with an extrusion mechanism 43 for releasing the molded article from the mold 40. The extrusion mechanism 43 includes an ejector pin 44, a support plate 45, a support rod 46, a spring 47, an extrusion plate 48, and a thrust bearing 49.

The ejector pin 44 is a rod-shaped member for extruding a molded article formed in the cavity 140. The ejector pin 44 penetrates the movable mold 41 and is inserted into the cavity 140. The support plate 45 is a plate member that supports the ejector pin 44. The ejector pin 44 is fixed to the support plate 45. The support rod 46 is fixed to the support plate 45 and inserted into a through hole provided in the movable mold 41. The spring 47 is disposed in a space between the movable mold 41 and the support plate 45 and allows the support rod 46 to be inserted. The spring 47 biases the support plate 45, so that a head portion of the ejector pin 44 forms a part of a wall surface of the cavity 140 during molding. The extrusion plate 48 is fixed to the support plate 45. The thrust bearing 49 is attached to the extrusion plate 48. The thrust bearing 49 is provided so that the head portion of the ball screw 54 does not damage the extrusion plate 48. A thrust sliding bearing or the like may be used instead of the thrust bearing 49.

### 1-1-2 Configuration Example of Mold

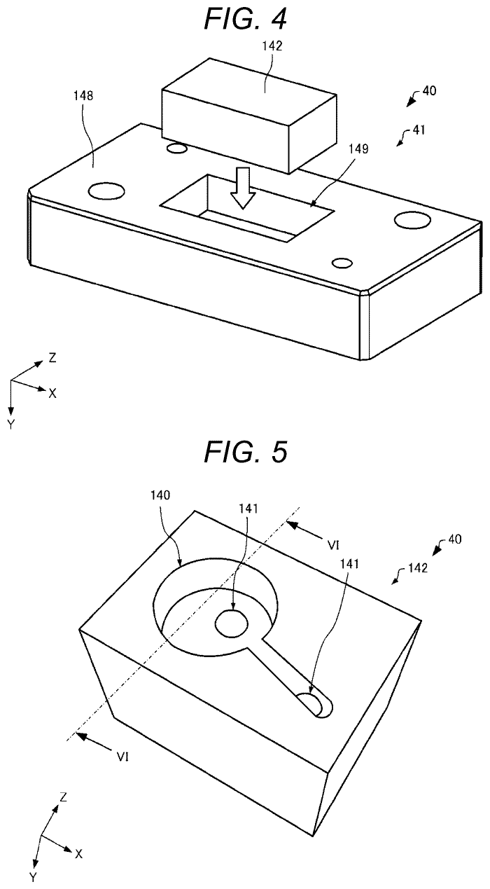

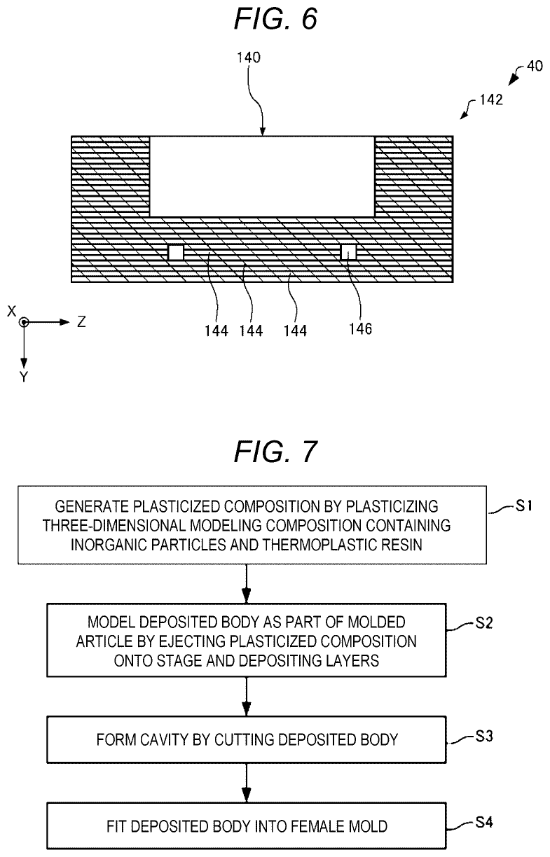

FIG. 4 is an exploded perspective view schematically showing a configuration example of the mold 40 of the injection molding apparatus 100. FIG. 5 is a perspective view schematically showing a deposited body 142 of the mold 40. FIG. 6 is a cross-sectional view taken along a line VI-VI of FIG. 5 and schematically showing the deposited body 142 of the mold 40.

As shown in FIGS. 4 to 6, the movable mold 41 of the mold 40 includes the deposited body 142 and a female mold 148. In the mold 40 shown in FIGS. 4 to 6, the deposited body 142 satisfies the conditions for the constituent material and the bending stress as described above. For convenience, the deposited body 142 is illustrated in a simplified manner in FIG. 4. For convenience, in FIGS. 4 to 6, the illustration of the fixed mold 42 of the mold 40 is omitted. The mold 40 is a mold used in the injection molding apparatus 100.

As shown in FIG. 4, the mold 40 is formed by fitting the deposited body 142 into a recessed portion 149 provided in the female mold 148. A material of the female mold 148 is, for example, metal.

As shown in FIG. 6, the deposited body 142 includes a plurality of layers 144. The deposited body 142 is formed by depositing the plurality of layers 144. The number of the plurality of layers 144 is not particularly limited. The deposited body 142 is a core.

The deposited body 142 has the cavity 140. A shape of the cavity 140 corresponds to the shape of the molded article molded by the injection molding apparatus 100. The cavity 140 is defined by the deposited body 142. As shown in FIG. 5, through holes 141 into which the ejector pin 44 is inserted are provided in a bottom surface of the cavity 140. In the illustrated example, two through holes 141 are provided.

As shown in FIG. 6, the deposited body 142 includes a cooling pipe 146. In the illustrated example, the cooling pipe 146 is provided in a +Y-axis direction of the cavity 140. A coolant for cooling the molded article flows through the cooling pipe 146. Examples of the coolant include water.

The mold 40 is manufactured by a three-dimensional modeling method using a three-dimensional modeling composition containing inorganic particles surface-modified with a silane coupling agent, and a thermoplastic resin. More specifically, for example, as will be described below, the three-dimensional modeling mold 40 is manufactured by a method for manufacturing a mold including a step of generating a plasticized composition by plasticizing a three-dimensional modeling composition, and a step of modeling the deposited body 142 to be a part of the mold 40 by ejecting the plasticized composition toward a stage and depositing the layers 144.

### 2 Three-Dimensional Modeling Composition

Next, the three-dimensional modeling composition according to the present disclosure will be described in detail.

The three-dimensional modeling composition according to the present disclosure contains inorganic particles surface-modified with a silane coupling agent and a thermoplastic resin, and the content of the silane coupling agent with respect to a unit surface area of the inorganic particles is 0.00233 g/m² or more and 0.00933 g/m² or less.

A three-dimensional modeling composition, which has excellent strength, effectively prevents the falling-off of the inorganic particles, and can be suitably used for manufacturing a modeled object, can be provided when such conditions are satisfied. In particular, a three-dimensional modeling composition, which excellent strength, effectively prevents the falling-off of the inorganic particles, and can be suitably used for manufacturing a mold for injection molding as a modeled object, can be provided.

More specifically, when the inorganic particles are surface-modified with a silane coupling agent, the adhesion between the inorganic particles and the thermoplastic resin is high, and accordingly, the mechanical strength of the obtained modeled object can be improved, and the inorganic particles can be prevented from falling off from the surface of the modeled object. When the content of the silane coupling agent with respect to the unit surface area of the inorganic particles is set to the above-described range, the mechanical strength, rigidity, and elastic modulus of the modeled object can be particularly improved.

In contrast, when the above conditions are not satisfied, the above excellent effects cannot be obtained.

For example, when the inorganic particles are not surface-modified with a silane coupling agent, the adhesion to the thermoplastic resin cannot be sufficiently high, and the mechanical strength of the obtained modeled object cannot be sufficiently high. In addition, the inorganic particles are likely to fall off from the surface of the obtained modeled object.

When the content of the silane coupling agent with respect to the unit surface area of the inorganic particles is less than the lower limit value, the strength and rigidity of the obtained modeled object may decrease even when the inorganic particles are surface-modified with a silane coupling agent. On the other hand, when the content of the silane coupling agent with respect to the unit surface area of the inorganic particles exceeds the upper limit value, the elastic modulus of the modeled object may decrease.

In the present specification, the three-dimensional modeling composition refers to a composition used for manufacturing, using a three-dimensional modeling method, a modeled object having a deposited structure in which a plurality of layers are deposited.

Further, the three-dimensional modeling composition and the modeled object manufactured by using the three-dimensional modeling composition have substantially the same composition. Therefore, when the mold according to the present disclosure satisfies the preferred conditions for the composition described below, it can be said that the following effects are exhibited.

In the following description, a case where the deposited body 142 of the mold 40 described above is manufactured as a modeled object according to a three-dimensional modeling method using the three-dimensional modeling composition according to the present disclosure will be mainly described.

### 2-1 Inorganic Particles

The three-dimensional modeling composition contains inorganic particles.

Examples of the inorganic material of the inorganic particles include various metals and metal compounds. Examples of the metal compound include various metal oxides, various metal hydroxides, various metal nitrides, various metal carbides, various metal sulfides, various metal carbonates, various metal sulfates, various metal silicates, various metal phosphates, various metal borates, talc, mica, and composites thereof.

Examples of the metal oxides include silica, alumina, titanium oxide, zinc oxide, zirconium oxide, tin oxide, magnesium oxide, sodium oxide, barium titanate, and potassium titanate.

Examples of the metal hydroxides include magnesium hydroxide, aluminum hydroxide, and calcium hydroxide.

Examples of the metal nitrides include silicon nitride, titanium nitride, and aluminum nitride.

Examples of the metal carbides include silicon carbide and titanium carbide.

Examples of the metal sulfide include zinc sulfide.

Examples of the metal carbonates include calcium carbonate and magnesium carbonate.

Examples of the metal sulfates include calcium sulfate and magnesium sulfate.

Examples of the metal silicates include calcium silicate and magnesium silicate.

Examples of the metal phosphates include calcium phosphate.

Examples of the metal borates include aluminum borate and magnesium borate.

The inorganic particles may contain an amorphous metal.

The amorphous metal generally has a thermal conductivity lower than that of a metal other than the amorphous metal and higher than that of a resin. Therefore, when the inorganic particles contain the amorphous metal, the heat accumulated in the mold is reduced and the cooling time of the molded article is shortened during manufacturing of the molded article using the mold, and missing such as chipping of the molded article, warpage of the molded article, and the like caused by poor filling of the three-dimensional modeling composition into the mold are more effectively prevented.

The amorphous metal contains, for example, iron, cobalt, and nickel as a main component.

The “main component” refers to a component having the highest proportion in an object, and is particularly preferably a component of 50 mass % or more.

The amorphous metal may contain, for example, other metal components such as tungsten, niobium, tantalum, titanium, zirconium, and hafnium in addition to the above components.

The inorganic particles may have any shape, and are preferably spherical.

Accordingly, for example, compared with a case where the inorganic particles are not spherical, a mold having a small difference in elastic modulus can be manufactured in a first direction and a second direction perpendicular to each other. As a result, the mechanical properties of the mold can be stabilized. Furthermore, the degree of freedom in design can be increased. Further, the fluidity of the three-dimensional modeling composition can be excellent, and the productivity of the mold using the three-dimensional modeling composition can be particularly improved.

An average particle diameter of the inorganic particles is not particularly limited, and is preferably 1 μm or more and 50 μm or less, and more preferably 1 μm or more and 25 μm or less.

Accordingly, the mechanical strength of the mold manufactured using the three-dimensional modeling composition can be particularly excellent, the occurrence of undesirable unevenness in the mold can be more effectively prevented, and the dimensional accuracy of the mold can be further improved. Further, the fluidity of the three-dimensional modeling compositions can be excellent, and the productivity of the mold using the three-dimensional modeling composition can be further improved. The inorganic particles can be more suitably prevented from falling off the surface of the mold.

In the present specification, the average particle diameter refers to an average particle diameter on a volume basis and can be determined by, for example, measuring a dispersion liquid obtained by adding a sample into methanol and dispersing the mixture for 3 minutes by an ultrasonic disperser, by a Coulter counter method particle size distribution measurement device (TA-II type manufactured by COULTER ELECTRONICS Inc.) with an aperture of 50 μm.

The content of the inorganic particles in the three-dimensional modeling composition is preferably 1 vol % or more and 50 vol % or less, more preferably 5 vol % or more and 45 vol % or less, and still more preferably 10 vol % or more and 43 vol % or less.

Accordingly, the fluidity of the three-dimensional modeling composition can be sufficiently excellent, and the mechanical strength of the mold which is finally obtained can be particularly improved.

The inorganic particles may be surface-modified at least with a silane coupling agent, which will be described in detail below, and may be surface-modified with other surface treatment agents in addition to the surface-modification with the silane coupling agent.

### 2-1-1 Silane Coupling Agent

The inorganic particles are surface-modified with a silane coupling agent.

The silane coupling agent has a function of modifying surfaces of the inorganic particles and improving the affinity with the thermoplastic resin.

Specifically, when the surfaces of the inorganic particles are treated with the silane coupling agent, an alkoxy group of the silane coupling agent is hydrolyzed into an OH group. Then, an OH group present on the surface of the inorganic particle and the OH group of the silane coupling agent are hydrogen-bonded and fixed to the surface of the inorganic particle. Further, with the dehydration condensation, an inorganic particle-oxygen-silicon bond is generated, and the silane coupling agent adheres to the surfaces of the inorganic particles. This bond is a stable covalent bond and is not thermally cleaved.

In a state where the silane coupling agent is bonded to the surfaces of the inorganic particles, a functional group that interacts with the thermoplastic resin is exposed on an outer surface. The functional group has reactivity and compatibility with the thermoplastic resin, and the bonding force between the inorganic particles and the thermoplastic resin can be increased by the chemical bonding and affinity between the functional group of the silane coupling agent and the thermoplastic resin. Accordingly, the mechanical strength of the finally obtained mold can be improved. In addition, falling-off of the inorganic particles from the surface of the mold is also prevented.

Examples of the functional group that interacts with the thermoplastic resin include a thiol group, an amino group, a methacrylic group, and an acrylic group.

Examples of the silane coupling agent include an amino-based silane coupling agent, an acrylic silane coupling agent, a ureido-based silane coupling agent, a vinyl-based silane coupling agent, a methacrylic silane coupling agent, an epoxy-based silane coupling agent, a mercapto-based silane coupling agent, and an isocyanate-based silane coupling agent. Among them, an amino-based silane coupling agent and an acrylic silane coupling agent are particularly preferred, and an amino-based silane coupling agent containing at least one primary amine is more preferred.

Accordingly, the affinity between the inorganic particles and the thermoplastic resin can be further increased.

Specific examples of the silane coupling agent include vinyltrimethoxysilane, vinyltriethoxysilane, phenyltriethoxysilane, 3-(acryloxy) propyltrimethoxysilane, N-2-aminoethyl-3-aminopropylmethyldimethoxysilane, γ-aminopropylmethyldiethoxysilane, γ-aminopropyltriethoxysilane, N-(β-aminoethyl)-γ-aminopropyltrimethoxysilane, 3-aminopropyltrimethoxysilane, γ-mercaptopropyltrimethoxysilane, γ-glycidoxypropyltrimethoxysilane, γ-glycidoxypropylmethyldimethoxysilane, γ-methacryloxypropyltrimethoxysilane, γ-methacryloxypropylmethyldimethoxysilane, vinyltris (β-methoxy-ethoxy) silane, β-(3, 4-epoxycyclohexyl)-ethyltrimethoxysilane, γ-phenylaminopropyltrimethoxysilane, ureidopropyltrimethoxysilane, ureidopropyltriethoxysilane, γ-isocyanatopropyltrimethoxysilane, and γ-isocyanatopropyltriethoxysilane.

The silane coupling agent preferably has an OH group as a functional group.

The OH group in the silane coupling agent is subjected to a dehydration condensation reaction with the OH group present on the surface of the inorganic particle to form an inorganic particle-oxygen-silicon bond. With such a covalent bond formation reaction, the silane coupling agent is fixed to the surfaces of the inorganic particles.

Even when a general silane coupling agent having an alkoxy group and having no OH group is used, a reaction in which an alcohol corresponding to the alkoxy group is eliminated from the silane coupling agent, that is, a hydrolysis reaction is allowed to proceed in advance, and then, a reaction of forming a covalent bond as described above can be allowed to proceed. However, when the general silane coupling agent having an alkoxy group and having no OH group is used, the alcohol, which is a volatile organic compound, is released to the outside of the system as a gas, and thus environmental measures are required. When the general silane coupling agent having an alkoxy group and having no OH group is used, and a mold is manufactured using the three-dimensional modeling composition, bubbles caused by the alcohol are mixed into the plasticized three-dimensional modeling composition, and defects such as chipping and voids are likely to occur in the obtained mold.

In contrast, the occurrence of the problems as described above can be suitably prevented by using a silane coupling agent having an OH group as a functional group. The step of the hydrolysis reaction as described above can be omitted or simplified, and therefore, the productivity of the three-dimensional modeling composition can be further improved.

Such a silane coupling agent is generally nonflammable and can reduce the amount of volatile organic compounds generated, and thus is advantageous from the viewpoint of environmental measures and the like.

The silane coupling agent having an OH group as a functional group as described above can be suitably manufactured by performing a hydrolysis reaction using a general silane coupling agent having an alkoxy group and having no OH group as a raw material.

The content of the silane coupling agent with respect to the unit surface area of the inorganic particles is preferably 0.00233 g/m² or more and 0.00933 g/m² or less, more preferably 0.003 g/m² or more and 0.008 g/m² or less, and still more preferably 0.004 g/m² or more and 0.006 g/m² or less.

Accordingly, the above-described effects are remarkably exerted.

The content of the silane coupling agent with respect to 100 parts by mass of the inorganic particles is preferably 0.05 parts by mass or more and 0.2 parts by mass or less, more preferably 0.06 parts by mass or more and 0.18 parts by mass or less, and still more preferably 0.08 parts by mass or more and 0.15 parts by mass or less.

Accordingly, the generation of gas can be more effectively prevented, and the mechanical strength, rigidity, and elastic modulus of the mold to be manufactured can be further improved.

### 2-2 Thermoplastic Resin

The three-dimensional modeling composition contains a thermoplastic resin.

Examples of the thermoplastic resin include polyphenylene sulfide, an ABS resin, polypropylene, polyethylene, polyacetal, polyvinyl chloride, polyamide, polylactic acid, polycarbonate, modified polyphenylene ether, polybutylene terephthalate, polyethylene terephthalate, polysulfone, polyethersulfone, polyarylate, polyimide, polyamideimide, polyetherimide, and polyether ether ketone. Among them, polyphenylene sulfide, polyimide, and polyether ether ketone are particularly preferred.

The content of the thermoplastic resin in the three-dimensional modeling composition is preferably 40 vol % or more and 99 vol % or less, more preferably 50 vol % or more and 95 vol % or less, and still more preferably 55 vol % or more and 90 vol % or less.

Accordingly, the fluidity of the three-dimensional modeling composition is sufficiently improved, and the mechanical strength of the mold to be manufactured can be further improved.

### 2-3 Other Components

The three-dimensional modeling composition may contain components other than the components described above. Hereinafter, such components are also referred to as other components.

Examples of other components include inorganic particles that are not surface-modified with the silane coupling agent, a colorant, a fixing agent, a fungicide, a preservative, an antioxidant, an ultraviolet absorber, a chelating agent, and a pH adjusting agent.

A total content of the other components in the three-dimensional modeling composition is preferably 10 mass % or less, more preferably 7 mass % or less, and still more preferably 5 mass % or less.

### 3 Method for Manufacturing Mold

Next, a method for manufacturing the mold will be described with reference to the drawings.

FIG. 7 is a flowchart illustrating the method for manufacturing the mold.

First, as shown in FIG. 7, in step S1, a plasticized composition is generated by plasticizing a three-dimensional modeling composition containing an amorphous metal and a thermoplastic resin.

The three-dimensional modeling composition contains the inorganic particles surface-modified with a silane coupling agent, and the thermoplastic resin.

The three-dimensional modeling composition is prepared, for example, by kneading the inorganic particles surface-modified with a silane coupling agent and the thermoplastic resin with a twin-screw extruder. In the preparation of the three-dimensional modeling composition, components other than the inorganic particles surface-modified with the silane coupling agent and the thermoplastic resin may be used in addition thereto.

In the step of generating the plasticized composition, for example, the plasticized composition is generated using a flat screw as described below.

Next, in step S2, the deposited body 142 as a part of the mold 40 is modeled by ejecting the plasticized composition toward the stage and depositing the layers 144.

In the step of modeling the deposited body 142, for example, the deposited body 142 including the cooling pipe 146 is modeled.

Next, in step S3, the cavity 140 is formed by cutting the deposited body 142.

The cutting of the deposited body 142 is performed using, for example, a cutting tool as described below. In the step of modeling the deposited body 142, which is step S2, the cavity 140 may be formed. In this case, step S3 may be omitted.

Next, in step S4, as shown in FIG. 4, the deposited body 142 is fitted to the female mold 148.

The mold 40 can be manufactured through the steps as described above.

### 4 Three-Dimensional Modeling Device

Next, a three-dimensional modeling device used in the method for manufacturing a mold will be described.

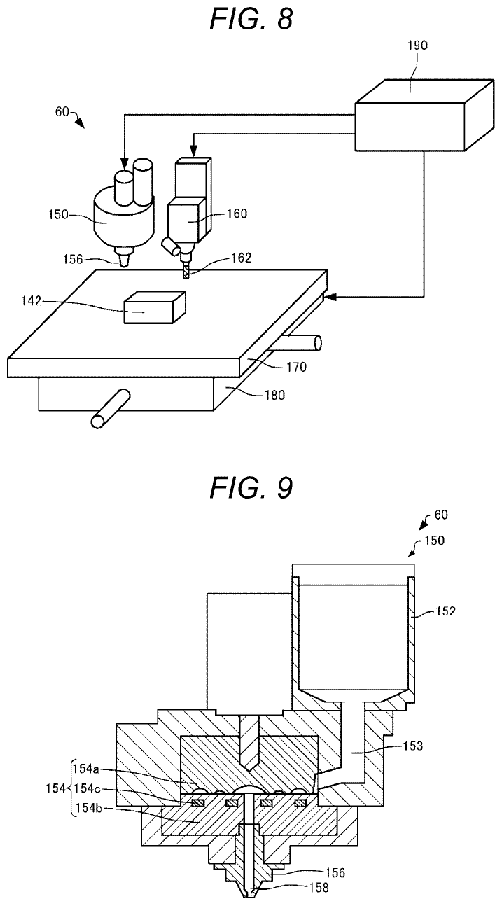

The method for manufacturing the mold is performed using the three-dimensional modeling device. FIG. 8 is a diagram schematically showing a configuration example of the three-dimensional modeling device used for manufacturing a mold. A three-dimensional modeling device 60 models the deposited body 142 that is a part of the mold 40.

As shown in FIG. 8, the three-dimensional modeling device 60 includes a modeling unit 150, a cutting unit 160, a stage 170, a movement mechanism 180, and a control unit 190.

The three-dimensional modeling device 60 ejects the plasticized composition from a nozzle 156 of the modeling unit 150 to the stage 170 and drives the movement mechanism 180 to change relative positions between the nozzle 156 and the stage 170. Accordingly, the modeling unit 150 deposits the deposited body 142 on the stage 170. For convenience, the deposited body 142 is illustrated in a simplified manner in FIG. 8.

Further, the three-dimensional modeling device 60 rotates a cutting tool 162 of the cutting unit 160 and drives the movement mechanism 180 to change relative positions between the cutting tool 162 and the stage 170. Accordingly, the cutting unit 160 cuts the deposited body 142 deposited on the stage 170. In this way, the three-dimensional modeling device 60 models the deposited body 142 having a desired shape.

Here, FIG. 9 is a cross-sectional view schematically showing the modeling unit 150.

As shown in FIG. 9, the modeling unit 150 includes, for example, a material supply unit 152, a plasticizing unit 154, and the nozzle 156.

The material supply unit 152 supplies a modeling material to the plasticizing unit 154. The modeling material is charged into the material supply unit 152. The material is, for example, a pellet-shaped or powder-shaped three-dimensional modeling composition. The material supply unit 152 is implemented by, for example, a hopper. The material supply unit 152 and the plasticizing unit 154 are connected by a supply path 153 provided below the material supply unit 152. The modeling material charged into the material supply unit 152 is supplied to the plasticizing unit 154 via the supply path 153.

The plasticizing unit 154 has the same configuration as the plasticizing device 10 of the injection molding apparatus 100 shown in FIG. 1. In other words, the plasticizing unit 154 includes a flat screw 154a, a barrel 154b, and the heater 154c. The plasticizing unit 154 plasticizes the modeling material supplied from the material supply unit 152 to generate a paste-shaped plasticized composition having fluidity, and guides the paste-shaped plasticized composition to a nozzle hole 158 provided in the nozzle 156.

The nozzle 156 ejects the plasticized composition generated by the plasticizing unit 154 toward the stage 170.

As shown in FIG. 8, the cutting unit 160 is a device that rotates a cutting tool 162 attached to a tip on the stage 170 side to cut the deposited body 142 deposited on the stage 170. For example, the cutting unit 160 cuts the deposited body 142 to form the cavity 140. As the cutting tool 162, for example, a flat end mill or a ball end mill is used. The control unit 190 controls the movement mechanism 180 to change the relative position between the cutting tool 162 and the deposited body 142 deposited on the stage 170, so that the cutting position is controlled.

The deposited body 142 is deposited on the stage 170. In the illustrated example, the deposited body 142 is directly provided on the stage 170. Although not illustrated, the deposited body 142 may be provided on the stage 170 via a base plate. Then, the mold 40 may be manufactured by fitting the deposited body 142 and the base plate to the female mold 148.

The movement mechanism 180 supports the stage 170. In the illustrated example, the movement mechanism 180 is configured as a three-axis positioner that moves the stage 170 along three axes perpendicular to one another relative to the modeling unit 150 and the cutting unit 160.

The movement mechanism 180 may move the modeling unit 150 and the cutting unit 160 relative to the stage 170 without moving the stage 170. The movement mechanism 180 may move both the stage 170, and the modeling unit 150 and the cutting unit 160. The movement mechanism 180 may have a function of inclining the stage 170 relative to a horizontal plane. The movement mechanism 180 may have a function of inclining the nozzle 156 and the cutting tool 162.

The control unit 190 is implemented by, for example, a computer including a processor, a main storage device, and an input and output interface for inputting and outputting signals from and to the outside. The control unit 190 controls the modeling unit 150, the cutting unit 160, and the movement mechanism 180, for example, by the processor executing a program read into the main storage device. The control unit 190 may be implemented by a combination of a plurality of circuits instead of a computer.

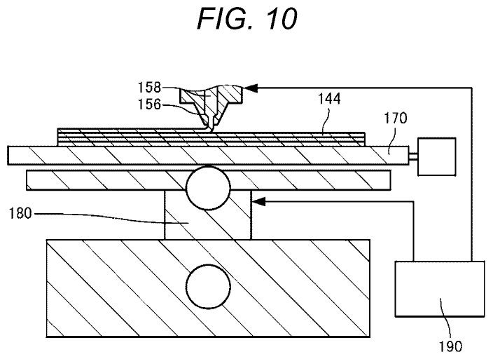

Here, FIG. 10 is a cross-sectional view schematically showing a step of manufacturing the deposited body 142 in the three-dimensional modeling device 60.

As shown in FIG. 10, the control unit 190 causes the plasticized composition to be ejected from the nozzle 156 while maintaining a distance between the stage 170 and the nozzle 156 and changing a relative position of the nozzle 156 with respect to the stage 170 in a direction along an upper surface of the stage 170. The plasticized composition ejected from the nozzle 156 is continuously deposited on the stage 170 in a moving direction of the nozzle 156, and the layer 144 is formed.

The control unit 190 repeats the scanning with the nozzle 156 to form a plurality of layers 144. Specifically, after forming one layer 144, the control unit 190 moves the relative position of the nozzle 156 with respect to the stage 170 upward. Then, a layer 144 is further deposited on the layer 144 formed so far to model the deposited body 142.

The control unit 190 may temporarily interrupt the ejection of the plasticized composition from the nozzle 156, for example, when the nozzle 156 is moved upward after the layer 144 corresponding to one layer is deposited or when a discontinuous path is modeled. In this case, the control unit 190 controls a butterfly valve or the like (not shown) provided in the nozzle hole 158 to stop the ejection of the plasticized composition from the nozzle 156. After changing the relative position of the nozzle 156 with respect to the stage 170 as necessary, the control unit 190 opens the butterfly valve to restart the ejection of the plasticized composition, thereby restarting the deposition of the plasticized composition.

As described above, the deposited body 142 constituting a part of the mold 40 used in the injection molding apparatus 100 is manufactured.

As described above, although the present disclosure has been described with reference to the preferred embodiment of the present disclosure, the present disclosure is not limited thereto.

For example, in the present disclosure, a composition other than the three-dimensional modeling composition described above may be used in addition to the three-dimensional modeling composition described above.

In the method for manufacturing the mold, an order of the steps and treatments is not limited to the order described above, and at least a part of the steps and the treatment may be replaced.

In the method for manufacturing the mold, a pretreatment step, an intermediate treatment step, and a post-treatment step may be performed as necessary.

In the three-dimensional modeling device, the configuration of each part can be replaced with any configuration exhibiting the same function, and any configuration can also be added.

The mold is not limited to the one manufactured using the three-dimensional modeling device as described above.

The injection molding apparatus and the mold are not limited to those having the configurations described above.

In addition, the three-dimensional modeling composition can be used for manufacturing a modeled object other than the mold as described above.

### EXAMPLES

Hereinafter, the present disclosure will be described in more detail with reference to specific Examples, but the present disclosure is not limited to these Examples. In the following description, the treatment for which the temperature condition is not particularly indicated is performed at room temperature, specifically 25° C. In addition, temperature conditions are also not particularly shown for various measurement conditions, and the measurement conditions are numerical values at room temperature, specifically 25° C.

### 5 Preparation of Three-Dimensional Modeling Composition

### Example 1

A polyphenylene sulfide resin as a thermoplastic resin and inorganic particles surface-modified with a silane coupling agent were mixed and kneaded to prepare a three-dimensional modeling composition.

FZ-2100 manufactured by DIC Corporation was used as the polyphenylene sulfide resin, AW2-08 PF5-F manufactured by Epson Atmix Corporation, which is iron powder having an average particle diameter of 4 μm, was used as the inorganic particles, and KBP-90 manufactured by Shin-Etsu Chemical Co., Ltd. was used as the silane coupling agent.

The prepared three-dimensional modeling composition contained 60 vol % of the polyphenylene sulfide resin and 40 vol % of inorganic particles surface-modified with a silane coupling agent. The content of the silane coupling agent with respect to the unit surface area of the inorganic particles was 0.004667 g/m², and the content of the silane coupling agent with respect to 100 parts by mass of the inorganic particles was 0.1 parts by mass.

The content of the silane coupling agent with respect to the unit surface area of the inorganic particles was calculated on the assumption that all the inorganic particles were perfect spheres having a diameter that is the average particle diameter. The same applies to Examples and Comparative Examples described below.

### Example 2

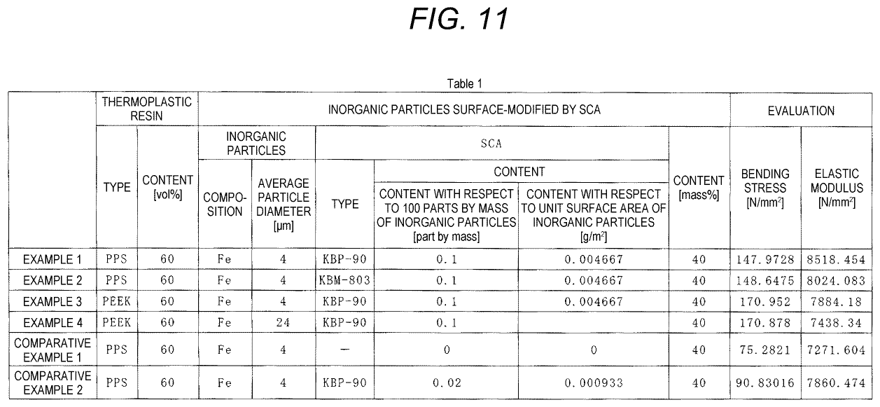

A three-dimensional modeling composition was prepared in the same manner as in Example 1 except that KBM-803 manufactured by Shin-Etsu Chemical Co., Ltd. was used as the silane coupling agent instead of KBP-90 manufactured by Shin-Etsu Chemical Co., Ltd. and the amount of the silane coupling agent used with respect to the inorganic particles was changed to obtain the configuration shown in FIG. 11.

### Examples 3 and 4

A three-dimensional modeling composition was prepared in the same manner as in Example 1 except that a polyether ether ketone resin was used as the thermoplastic resin instead of the polyphenylene sulfide resin, and the average particle diameter of the inorganic particles was set as shown in FIG. 11 to obtain the configuration shown in FIG. 11. As the polyether ether ketone resin, VICTREX PEEK 90G manufactured by VICTREX was used.

### Comparative Example 1

A three-dimensional modeling composition was prepared in the same manner as in Example 1 except that the inorganic particles were not surface-modified with the silane coupling agent.

### Comparative Example 2

A three-dimensional modeling composition was prepared in the same manner as in Example 1 except that the content of the silane coupling agent with respect to the unit surface area of the inorganic particles was changed to 0.000933 g/m².

In FIG. 11, the polyphenylene sulfide resin is indicated as “PPS”, the polyether ether ketone resin is indicated as “PEEK”, the silane coupling agent is indicated as “SCA”, KBP-90 manufactured by Shin-Etsu Chemical Co., Ltd. is indicated as “KBP-90”, and KBM-803 manufactured by Shin-Etsu Chemical Co., Ltd. is indicated as “KBM-803”.

The structure of each silane coupling agent is shown below.

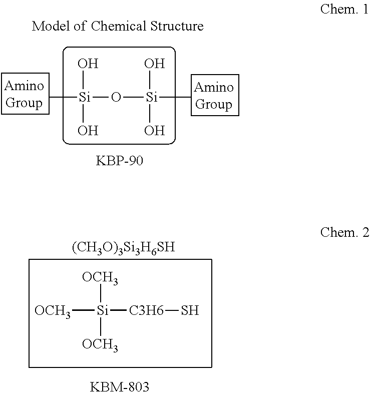

### 6 Evaluation

The three-dimensional modeling compositions obtained as described above were evaluated as follows.

### 6-1 Measurement of Bending Stress and Elastic Modulus

A plate-shaped test piece having a length of 50 mm, a width of 10 mm, and a thickness of 4 mm was produced by injection molding using each of the three-dimensional modeling compositions of Examples and Comparative Examples.

For each of the produced test pieces, the bending stress and the bending elastic modulus were measured by a three-point bending test using a three-point bending test jig in accordance with a method described in JIS K7171: 2016. A distance between the fulcrums of the bending test jig was 40 mm, and the bending speed was 1 mm/min. The measurement region of the bending elastic modulus was a region where the strain was 0.05% or more and 0.25% or less.

The measurement was performed for five test pieces, and an average value was calculated.

FIG. 11 is a table showing evaluation results of the three-dimensional modeling compositions of Examples and Comparative Examples together with compositions.

As is clear from FIG. 11, a modeled object having excellent mechanical strength was obtained in the present disclosure. When the modeled object having such a high mechanical strength is implemented as a mold used in an injection molding apparatus, the possibility of damage in a fine structure or a thin portion of the mold can be reduced even when a high pressure during injection molding, for example, a pressure of 100 MPa to 200 MPa is applied. In contrast, in Comparative Examples, satisfactory results were not obtained.

A plate-shaped test piece having a length of 50 mm, a width of 10 mm, and a thickness of 4 mm was produced using each of the three-dimensional modeling compositions of Examples and Comparative Examples by adopting a three-dimensional modeling method using the three-dimensional modeling device as shown in FIGS. 8 and 9 instead of injection molding. When the bending stress and the bending elastic modulus were measured for these test pieces in the same manner as described above, excellent results were obtained in the same manner as described above.

### 6-2 Evaluation of Mold

The three-dimensional modeling device as shown in FIGS. 8 and 9 was prepared, and the deposited body shown in FIGS. 5 and 6 was produced using the three-dimensional modeling compositions of Examples and Comparative Examples.

The mold shown in FIG. 4 was obtained using each deposited body obtained in this manner.

A molded body was repeatedly manufactured by injection molding using the injection molding apparatus (see FIGS. 1 to 3) including the mold. The injection molding pressure at this time was 200 MPa.

Thereafter, when the molds according to Examples and Comparative Examples were visually observed, falling-off of the inorganic particles was not observed, and a missing such as chipping did not occur in the molds of Examples. In addition, in the molded bodies produced using the molds of Examples, the defect derived from the missing as described above was not observed.

In contrast, in the molds of Comparative Examples, falling-off of the inorganic particles was observed, and chipping occurred. In addition, in the molded bodies produced using the molds of Comparative Examples, defects derived from the chipping as described above were observed.

### 6-3 Evaluation of Occurrence of Voids

The three-dimensional modeling device as shown in FIGS. 8 and 9 was prepared, and each of the three-dimensional modeling compositions of Examples and Comparative Examples was plasticized and ejected in a string shape from a nozzle to obtain a strand.

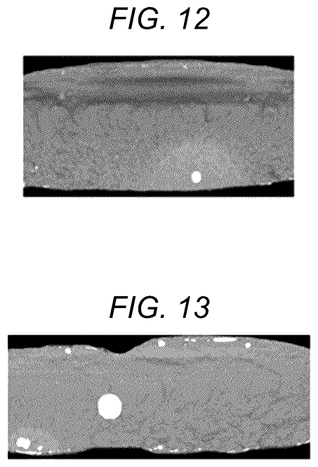

FIG. 12 is an image obtained by performing image J (image processing) on an image obtained by measuring, by a digital microscope (VHV), a strand ejected using the three-dimensional modeling composition of Example 1 containing KBP-90 manufactured by Shin-Etsu Chemical Co., Ltd. as a silane coupling agent. FIG. 13 is an image obtained by performing image J (image processing) on an image obtained by measuring, by a digital microscope (VHV), a strand ejected using the three-dimensional modeling composition of Example 2 containing KBM-803 manufactured by Shin-Etsu Chemical Co., Ltd. as a silane coupling agent.

As is clear from FIGS. 12 and 13, in the present disclosure, a three-dimensional modeling composition by which the generation of voids was suitably prevented was obtained. In contrast, in Comparative Examples, a large number of voids were generated.

From FIGS. 12 and 13, in Example 1 in which KBP-90, which is a silane coupling agent having an OH group as a functional group, was used, the number of voids in the strand was smaller than that in Example 2 in which KBM-803, which is a silane coupling agent having no OH group as a functional group, was used. The same tendency was found in Comparative Examples.

What is claimed is:

1. A mold for use in injection molding having a deposited structure in which a plurality of layers are deposited, the mold comprising:
a material containing inorganic particles surface-modified with a silane coupling agent, and a thermoplastic resin, wherein
the mold has a bending stress of 120 MPa or more as measured by a three-point bending strength test.

2. The mold according to claim 1, wherein
the mold has an elastic modulus of 8300 MPa or more as measured by the three-point bending strength test.

3. The mold according to claim 1, wherein
a content of the silane coupling agent with respect to a unit surface area of the inorganic particles is 0.00233 g/m² or more and 0.00933 g/m² or less.

4. The mold according to claim 1, wherein
a content of the silane coupling agent with respect to 100 parts by mass of the inorganic particles is 0.05 parts by mass or more and 0.2 parts by mass or less.

5. The mold according to claim 1, wherein
the silane coupling agent has an OH group functional group.

6. The mold according to claim 1, wherein
the inorganic particles include an amorphous metal.

7. The mold according to claim 1, wherein
the inorganic particles are spherical iron powder.

8. A three-dimensional modeling composition comprising:
inorganic particles surface-modified with a silane coupling agent; and
a thermoplastic resin, wherein
a content of the silane coupling agent with respect to a unit surface area of the inorganic particles is 0.00233 g/m² or more and 0.00933 g/m² or less.
